(19) United States
(12) Patent Application Publication
(10) Pub. No.: US 2007/0009337 A1
(43) Pub. Date: Jan. 11, 2007

(54) Composite dunnage bar system

(76) Inventors: Mohammed Mahmood, Troy, MI (US); Geoff O'Brien, Shelby Twp., MI (US); David Clyde Shifflet, Mt. Clemens, MI (US); Elvis Mandelli, Canton, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/389,911

(22) Filed: Mar. 27, 2006

Related U.S. Application Data
(60) Provisional application No. 60/693,682, filed on Jun. 24, 2005.

(51) Int. Cl. B60P 7/15

(52) U.S. Cl. 410/143

(57) ABSTRACT

A dunnage bar system 10 that includes an bar 12 with a generally rectangular cross section. In one embodiment, the bar has four external faces 14, 16, 18, 20 that are joined by arcuate corners 22. The four faces 14, 16, 18, 20 include an impact-absorbing face 14 that has two arms of a C-section 30, 32; a basal face 16 opposing the impact-absorbing face 14; and a pair of side faces 18, 20 that are oriented between the impact-absorbing and basal faces 14 and 16. Preferably, a pair of channels 36 extend at least partially along and within the bar 12. Each channel 36 has a pair of opposing internal major walls 40, 40′ and opposing internal minor walls 44, 44′. In alternative embodiments, one or more spacer members 70, 70′ are insertable into the channels 36 for torsional rigidity and added support. Each wall terminates in an internal corner having a radius. The invention also includes a process for making the disclosed composite bar system.

### CROSS-REFERENCE

This application claims the benefit of and priority from provisional patent application No. 60/693,682, which was filed on Jun. 24, 2005 and is incorporated herein by reference.

### BACKGROUND OF THE INVENTION

1. Field of the Invention

The invention relates to a dunnage bar system that can be used as a swing bar or a dunnage bar. Besides the product, the invention also includes the method by which the product is made.

2. Background Art

The word “dunnage” is an old sailing term for material placed between cargo to prevent shifting and avoid damage to ships and cargo. Today, dunnage, often in the form of jacks, pipes and supports, etc. is used to support loads and prop tools and subassemblies up off the ground.

Dunnage bars may form part of a rack for transporting various parts and subassemblies, such as door panels, hoods, decklids, etc. (collectively “components” herein). Conventionally, such racks include a frame and a number of transverse bars supported on the frame. The racks can be deployed in the parts manufacturer's plant and then shipped to the assembly plant by air, truck or train. These racks can also be used to move components within the plants.

When a laden rack is shipped, it can be subjected to sudden stops and starts that subject the dunnage bar to severe impact. Accordingly, the bar must be strong enough to withstand the weight of the parts and the impact without permanent change to its shape. Ideally, the bar must withstand impact with minimum twisting or bending without affecting its performance and useful life.

Dunnage bars are generally made out of aluminum or steel. The cost of an aluminum bar exceeds that of a steel bar. Due to its recyclable properties, the aluminum bar is subject to theft. Steel bars are generally heavy and are susceptible to corrosion. Further, steel bars are generally not sufficiently flexible. When stressed beyond a yield point, they permanently deform.

Conventional dunnage bars are secured at their ends to a rack by nuts and bolts. One problem (whether made of metals or composites) that has occurred with prior composite bars is that over time cracks can occur that originate from areas of stress concentration, such as bolt holes.

Among the art identified in pre-filing search are the following U.S. Pat. Nos. Des. 324,506; 4,007,837; 4,093,251; 4,238,550; 4,650,381; 4,733,781; 4,826,384; 4,911,312; 4,919,277; 4,921,100; 5,326,204; 5,378,093; 5,418,038; 5,466,103; 5,484,643; 5,511,916; 5,582,495; 5,584,624; 5,603,419; 5,605,239; 5,876,164; 5,876,165; 6,146,068; 6,164,440; 6,394,721 B1; 6,497,542 B1; 6,568,891 B2; 6,572,313 B2; 6,648,142 B1; 6,648,572 B2; 6,679,378 B1; 6,685,405 B2; 6,746,189 B2; 6,786,687; B2.

### SUMMARY OF THE INVENTION

One object of the present invention is to provide a dunnage bar system which is composed of one part, is rugged and durable in use and requires no additional coatings to resist corrosion.

Accordingly, the dunnage bar of the present invention is a one piece construction bar of a prescribed shape which requires no welding and no special finish for corrosion resistance.

It is another object of the invention to provide an improved dunnage bar of a composite material that replaces steel, while providing weight savings, cost savings, and ergonomic benefits.

Further, an object of the invention is to provide ways to attach the ends of the dunnage bar to the rack or to a swing arm in such a manner as to avoid creating an area of weakness. Conventionally, the dunnage bar sometimes requires counterweights when used as a swing bar to assist the operators in lifting it. Ergonomically superior due to its lower weight, the inventive composite bar eliminates the need for cumbersome, heavy and costly steel counterweights. The disclosed composite bar also eliminates operator injuries due to sharp rusted projections and sudden unplanned movement of the counterweights.

The bar has an internal structure(s) that is formed from blended materials which provide the strength necessary to meet or exceed the chemical and mechanical properties of steel. The composite bar disclosed has a glass matrix and blended resins to achieve strength at a lower cost and a lower weight.

As mentioned above, aluminum bars were often the target of theft. In contrast, the inventive composite dunnage bars tend not to be a pilferage target, given their low scrap value.

Conventionally, a groove in the dunnage bar may accommodate a separate reinforcing member. This is unnecessary in the current one piece rectangular construction because reinforcement is provided by the one piece unit alone.

Prior dunnage bars were subject to permanent impact damage in conventional use. In contrast, the disclosed composite bar is more resilient. It does not permanently deform under load conditions under which steel or aluminum bends and thus become unusable.

Thus, the dunnage bar system of the present invention includes a bar with a generally rectangular cross section. In one embodiment, the bar has four external faces that are joined by arcuate corners. The four faces include an impact-absorbing face that has two arms of a C-section; a basal face opposing the impact-absorbing face; and a pair of side faces that extend between the impact-absorbing and basal faces. Preferably, one or more channels extend at least partially along and within the bar. In one embodiment, each channel has a pair of opposing internal major walls and opposing internal minor walls. Each wall terminates in a corner having an internal radius.

In one aspect of the invention, a spacer member is inserted into each channel in the pair of channels at each end of a bar. The spacer members have apertures that align with bolt holes that are defined within the ends of the dunnage bar. After insertion of the spacer members, a bolt may be inserted through the bolt holes and spacer member. Thus, the ends of the dunnage bar are reinforced and protected against the adverse effects of over-torquing and bolt hole wear.

In another embodiment, a two-hole spacer member is provided for each channel in a dunnage bar that has two holes at each end.

In one variation of a process for making the composite bar system, the steps include:

a) preparing first resin bath and submerging roving;

b) introducing inner channel mats;

c) begin forming inner channel mats around mandrels;

d) continue forming inner channel mats around mandrels;

e) directing roving to center of bar;

f) finally forming inner channel mats around mandrels;

g) forming outer and “C” channel mats before submerging all roving and mats into a second resin bath;

h) continue forming outer and “C” channel mats;

i) shaping the final profile optionally by squeezing the final resin from the outer and “C” channel mats;

j) resumed forming of outer and “C” channel mats;

k) finally forming outer and “C” channel mats and optionally squeezing excess resin from pre-size shape;

l) introducing final form of profile of outer and “C” channel mats at front of die to provide early curing;

m) elevating product temperature and heating die up to curing temperature;

n) hardening the final bar profile; and

o) at least partially curing the bar in the heated die, cooling and severing.

These and other objects, features and advantages of the invention will become more apparent as the following description continues, especially when considered with the accompanying drawings.

### BRIEF DESCRIPTION OF THE DRAWINGS

FIG. 1 is a perspective view of a dunnage rack incorporating the dunnage bar of the present invention;

FIG. 2 is a perspective view of a section of the dunnage bar without a protective insert in place;

FIG. 3 is an end elevation view of the dunnage bar of FIG. 2;

FIG. 4 is an exploded view of a working mat that includes transverse continuous glass which is stitched to a random glass fiber mat;

FIGS. 5(a) and 5(b) are process flow diagrams that illustrate the main steps in manufacturing the disclosed product;

FIG. 6 schematically illustrates a spacer member that optionally is inserted into the ends of a dunnage bar having one bolt hole at each end to strengthen and support the attachment of bar ends to a rack or swing arm.

FIG. 7 is a perspective view of a pair of spacer members before insertion into the dunnage bar;

FIG. 8 is a perspective end view of the dunnage bar showing the spacers located in their inserted positions;

FIG. 9 is an end elevational view of the configuration depicted in FIG. 8;

FIG. 10 is a top plan view of a spacer member before insertion and schematically after insertion into the dunnage bar;

FIG. 11 schematically illustrates a pair of two-hole spacer members that optionally are inserted into the ends of a dunnage bar having two bolt holes at each end;

FIG. 12 is a perspective view of an end of a two-hole dunnage bar before insertion of the spacer members;

FIG. 13 is an end elevation view of the dunnage bar after the spacing members have been inserted;

FIG. 14 is a top plan view of a two-hole spacer member; and

FIG. 15 is a side view, partially broken away, of a dunnage bar with a single two-hole spacer member inserted in one channel.

### DETAILED DESCRIPTION OF THE PREFERRED EMBODIMENT

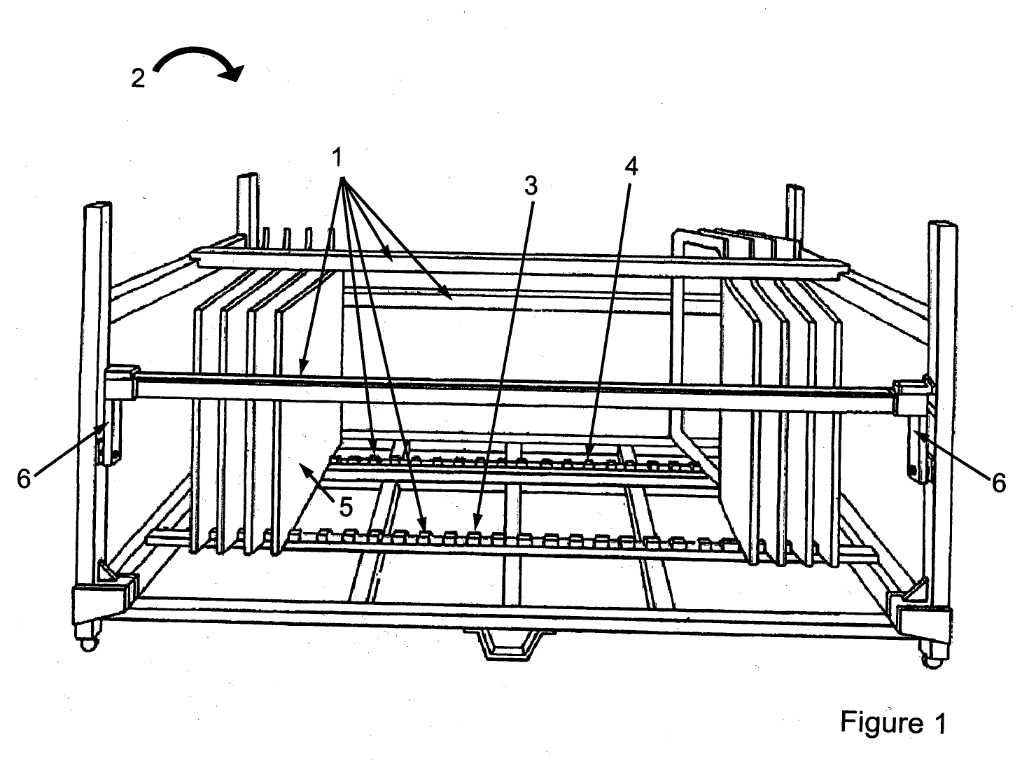

FIG. 1 depicts transverse dunnage bars 1 that can be located in virtually any part of a rack 2. The rack 2 is used to accommodate and transport a load such as panels 5 that are positioned within grooves 3, 4 supported by dunnage bars 1 or between suitable stops. Each dunnage bar 1 is of a one piece construction that in one embodiment is open at both ends. There is no welding or assembly required. Nor is any special finish step required for corrosion resistance.

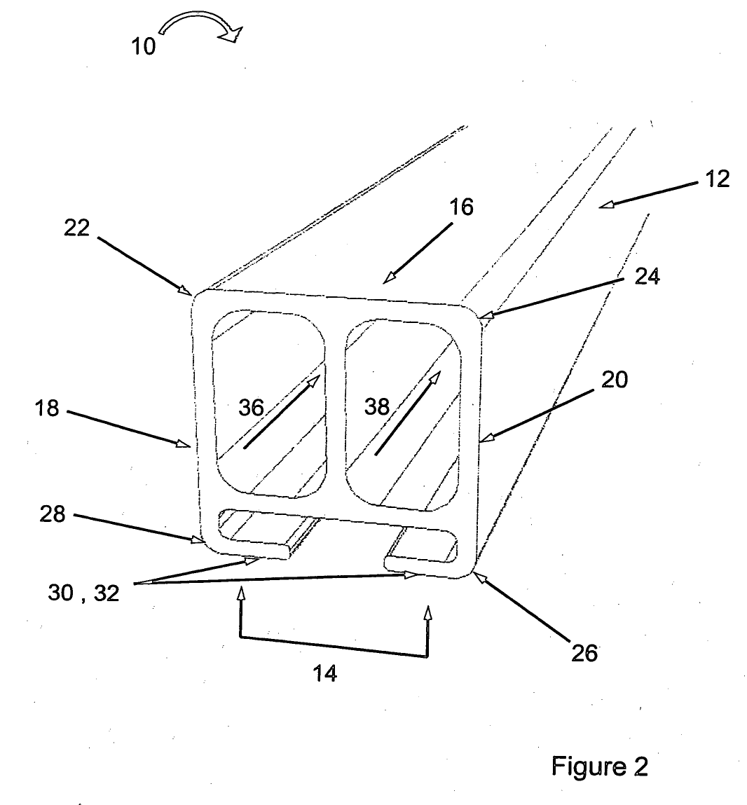

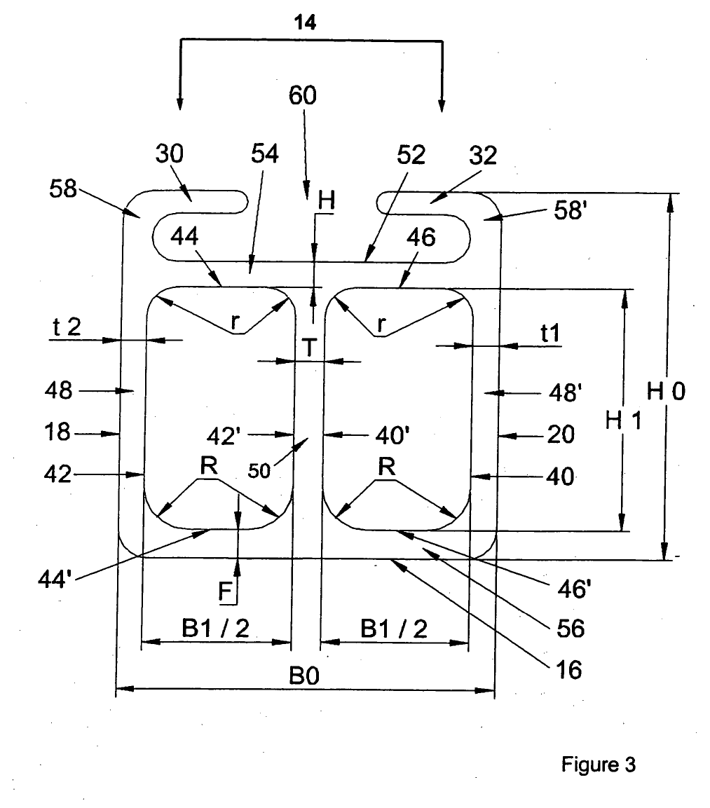

The disclosed dunnage bar system 10 (FIGS. 2-3) comprises a bar 12 with a generally rectangular cross-section. As used herein, the term “rectangular” includes “square.” The bar has four external faces: 14, 16, 18, and 20 that are joined by outside arcuate corners 22, 24, 26, 28. An impact-absorbing face 14 includes two arms 30, 32 of a C-section. A basal face 16 opposes the impact-absorbing face. Side faces 18, 20 are oriented between the impact-absorbing and basal faces. One or more, and preferably a pair of channels 36, 38 extend at least partially along and within the bar 12. Each channel 36, 38 has a pair of opposing internal major faces 40, 42 and opposing minor faces 44, 46. Though depicted as being generally rectangular, the channels 36, 38 may have a trapezoidal cross section.

Each face 40, 42, 44, 46 terminates in an internal corner having a radius. In FIG. 3, the radius (r) defines the radius adjacent the C-section or impact-absorbing face 14. The symbol (R) denotes the radius of the internal corners adjacent the basal face 16. It should be appreciated that (r) is not necessarily less than (R). Indeed, in some applications, (r) may be equal to or exceed (R). Rather than being an accident of the tooling process, either or both of the radii R and r are purposefully created in order to avoid stress concentration and failure of the major and minor faces of the channels.

As illustrated in FIGS. 2-3, the dunnage bar system 10 is further defined by a thickness (t₁) that separates an external side face 20 from an internal major face 40 of a channel 38. A thickness (t₂) separates another external side face 18 of the bar from an internal major face 42 of the other channel 36. Preferably, but not necessarily, t₁=t₂. A septum 50 separates the channels 36, 38 and has a thickness (T).

FIG. 3 depicts a preferred embodiment which includes two channels 36,38. It should be appreciated, however, that the invention is not so limited. In other embodiments, there may be more than two channels. In general, however, the disposition of channels should be such that they are generally symmetrical about a vertical axis that extends along the septum 50.

Continuing with primary reference to FIG. 3, the dunnage bar system 10 is also provided with a ceiling portion 54 that has a thickness (H). The ceiling portion 54 separates the internal minor faces 44, 46 from a foot portion 52 of the C-shaped impact-absorbing face 14. On the opposite external face of the dunnage bar system 10 is a floor portion 56 that has a thickness (F). It separates the external basal face 16 of the bar from the minor internal faces 44′, 46′ of the channels 36, 38.

In FIG. 3, arms 30, 32 of the C-section are supported by lateral risers 58, 58′ that form a portion of the external side walls 48, 48′. The two arms 30, 32 of the C-section external impact-absorbing face 14 are separated by an opening 60 therebetween. A generally T-shaped section of a protective strip (not shown) can be inserted into and received by the a groove in C-section 14 along at least a part of the length of the bar 12.

By experiment, an optimal ratio of r to R lies between 0.4 and 1.0. A determination of this range of optimal results followed impact (drop) test using 72 lb. weights; torsion (twist) testing using a torque between 20 and 80 ft/lb.; deflection measurements where the loads were recorded that produced a 3 inch deflection in a long dunnage bar and testing undertaken both at room temperatures and at temperatures of about −25 degrees Fahrenheit.

One testing procedure involved comparing the damage to a steel bar and a composite bar after impact. In that experiment, both bars were subjected to impacts from a 72 lb. projectile that was dropped from a height of about 1.4 meters. The bar measured 91.25 inches in length. It was observed that the composite bar had no permanent deflection, unlike the steel bar.

In torsion testing, a composite bar was twisted after being subjected to a torque of about 80 ft/lb. At one end of the bar, an 11° twist was observed. When the torque was removed, the bar reverted to its undeflected state. In contrast, when an 80 ft/lb torque was applied to a steel bar, an 88° deflection occurred. When the torque was removed, the bar had a permanent twist of about 12° in an undeflected state. In each case, the bars measured 100.5″ in length.

As noted earlier, the dunnage bar 1 (FIG. 1) can also be used as a swing bar. In use, a swing frame has laterally spaced side arms 6. Their inner ends are pivotably mounted to the side rails of the rack. Extending between the outer ends of the side arms is a transverse dunnage bar 1 which is constructed in accordance with this invention. As used herein, the term “inner” refers to a surface of the dunnage bar 1 (FIG. 1) that is positioned innermost in relation to a rack 2, of which the dunnage bar forms part. It should be understood, however, that the term “inner” should not be construed in a limiting manner. In use, the disclosed dunnage bar 1 may be oriented with the open C section positioned inwardly, outwardly, upwardly, downwardly, or in any intermediate position. See, e.g., FIGS. 2-3.

As mentioned above, the open C-section 14 (FIGS. 2-3) defines a groove or pocket that allows a cushioning dunnage insert to be longitudinally inserted into the C-section. The section provides a T-shaped groove for a protective strip to be received for material handling and securing purposes. The protective strip is preferably made of a flexible rubber or suitable elastomeric material. It has an body portion which fits within the pocket, and a nose portion which may project outwardly from the pocket through the opening 60 in the C-section 14. Preferably, the length of the protective strip approximates the length of the dunnage bar. In one embodiment, the strip has grooves along its length between a body portion and two nose portions thereof. The strip can be inserted in the C-section 14 and removed therefrom by sliding into and out of either end of the dunnage bar.

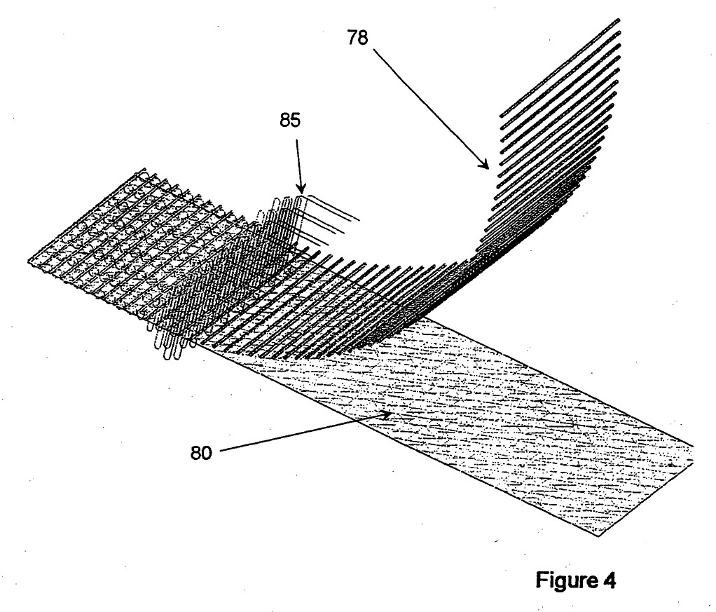

As depicted in FIG. 4, the material composition of the composite dunnage bar includes a transverse continuous 78 and random glass matrix 80 to obtain maximum strength. Preferably, the transverse continuous glass 78 is wrapped with random glass 80, to which it may be attached by stitching. Each wall is wrapped with random glass and then longitudinal glass is woven through the center of the random and continuous glass. Preferably, the total glass content is excess of 55% by weight.

Optionally, the resin includes a UV additive to provide UV protection. This material does not rust and therefore does not require corrosion-resistant coating.

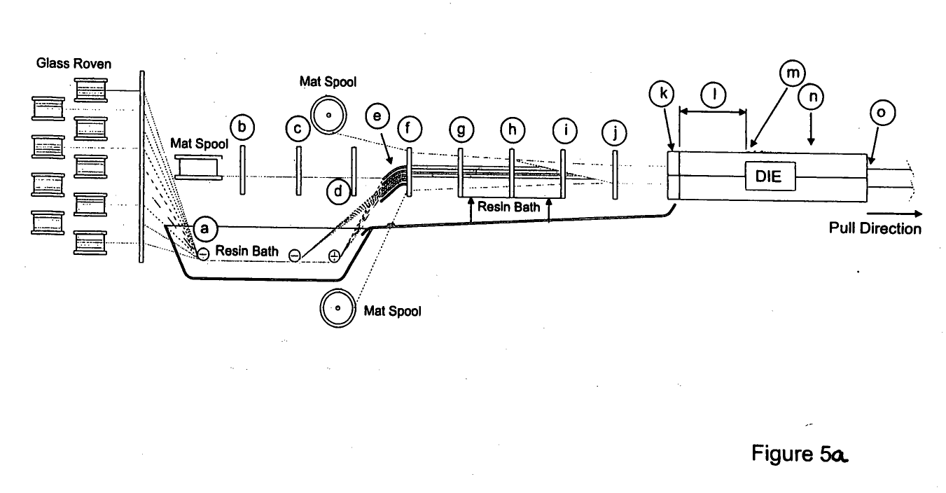

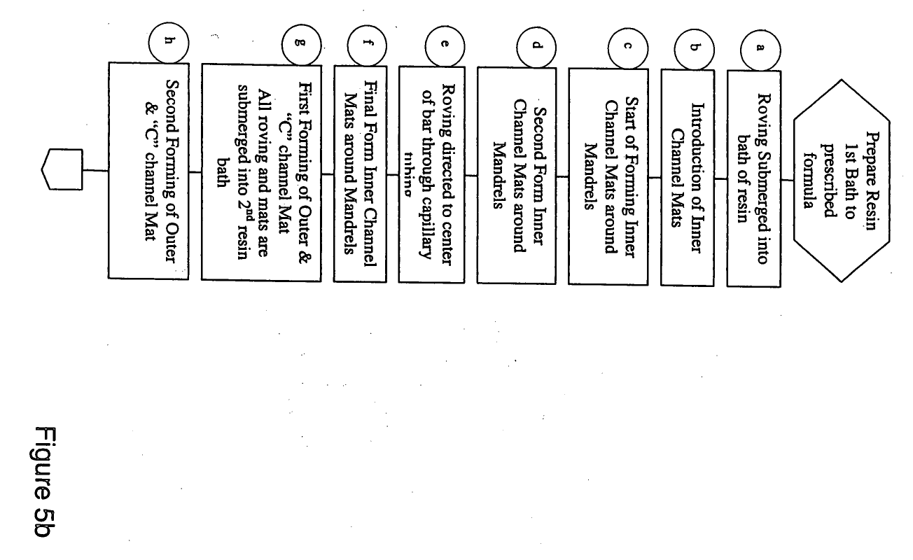

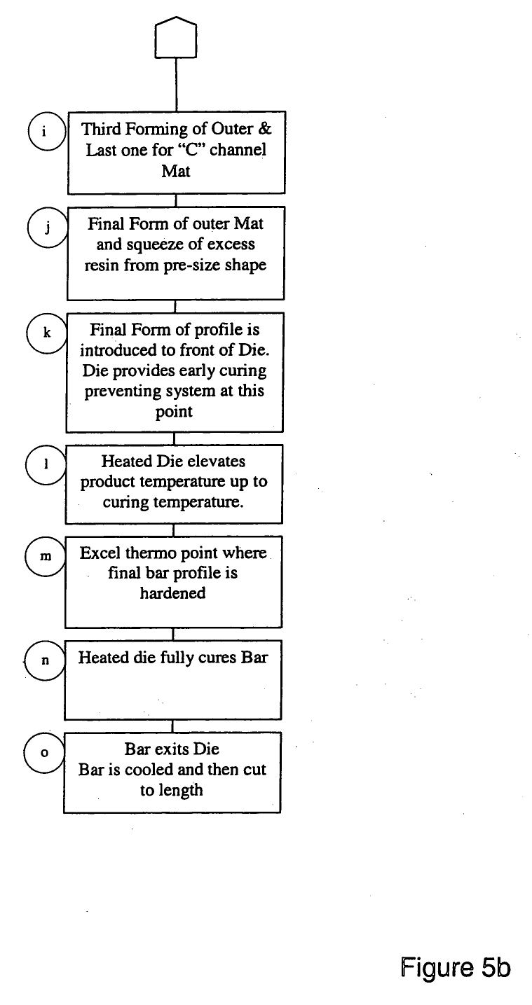

In one variation, the process (FIG. 5) involves continuous forming of the part. Preferably, the composite dunnage bar system of the present invention is prepared by a modified pultrusion process. As is known, the pultrusion process produces little waste material. Thermoset resins and fiber reinforcement are led through a resin impregnation area to coat the reinforcement with resin, through preform plates to begin to shape the fiber/resin bundle, and through a heated die to cure the resin. A cured part in the desired shape that requires no further processing exits from the die.

Numerous process variables can effect the quality of the pultruded composites. Such variables include pull speed, die temperature, quality of fiber/resin wet-out, and fiber volume.

Due to its continuous nature, the pultrusion process can be used to prepare composites of any desired length. As noted earlier, the composites may have profiles with simplex or complex geometry. One feature of conventional pultrusion processes, however, is that the product should preferably have a constant-cross section along its length. Travel through the die results in all surfaces on a protruded composite being smooth and finished. To avoid superficial fragmentation and splintering, a protective coating vail can be applied on top of a transverse continuous glass surface which in one embodiment is wrapped around a random glass layer that in turn covers a longitudinal glass layer. That layer itself in one embodiment, may be applied around a random glass layer that in turn may cover a transverse continuous glass layer.

As illustrated in FIGS. 4 and 5, one variation of the process begins with a shell that has continuous wrappings of transverse glass. The shell is then wrapped with random glass. Following an optional stitching step, the random glass wrapping is covered with longitudinal continuous glass. Next, a layer of randomly oriented glass is applied, which is then wrapped with transverse continuous glass. Finally, the layer of transverse continuous glass is covered with bail.

In one variation of a process (FIGS. 5(a) and 5(b)) for making the composite bar system, the steps include:

a) preparing first resin bath and submerging roving;

b) introducing inner channel mats;

c) begin forming inner channel mats around mandrels;

d) continue forming inner channel mats around mandrels;

e) directing roving to center of bar;

f) finally forming inner channel mats around mandrels;

g) forming outer and “C” channel mats before submerging all roving and mats into a second resin bath;

h) continue forming outer and “C” channel mats;

i) shaping the final profile optionally by squeezing the final resin from the outer and “C” channel mats;

j) resumed forming of outer and “C” channel mats;

k) finally forming outer and “C” channel mats and optionally squeezing excess resin from pre-size shape;

l) introducing final form of profile of outer and “C” channel mats at front of die to provide early curing;

m) elevating product temperature and heating die, up to curing temperature;

n) hardening the final bar profile; and

o) at least partially curing the bar in the heated die, cooling and severing.

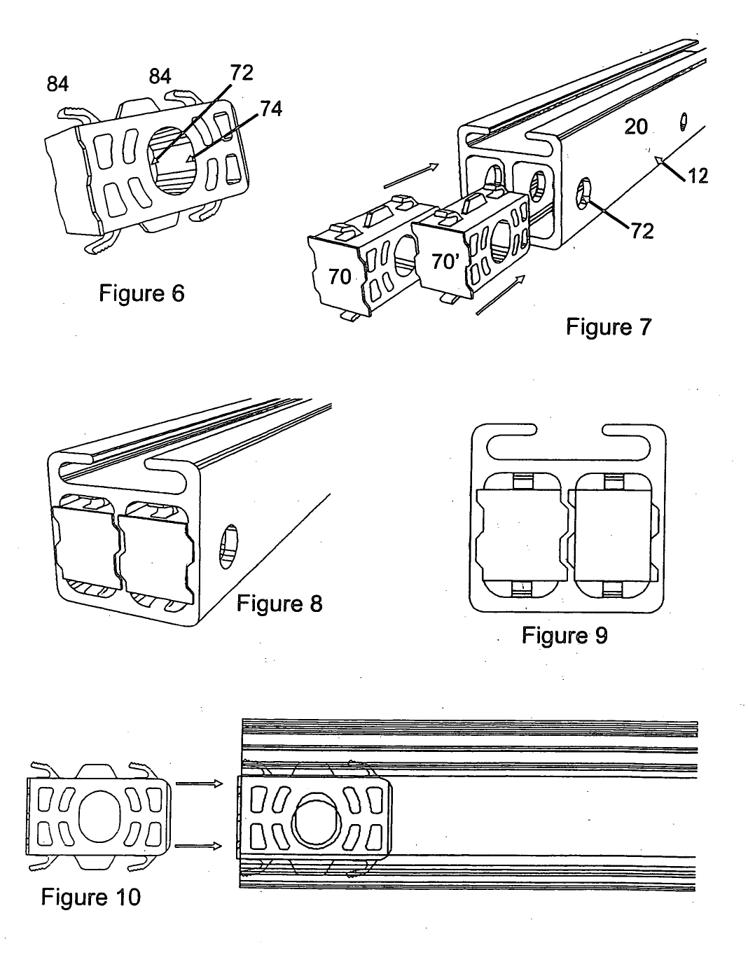

Turning now to FIGS. 6-10, one way to support and stabilize the dunnage bar in relation to a rack or swing arm is to provide spacer members 70, 70′ at the ends of the bar 12. A spacer member is provided in each channel. When the spacer member 70, 70′ is inserted, the channel 36, 38 respectively is prevented from collapsing when nuts and bolts at the bar ends are secured with otherwise excessive torque. In use, repeated percussion, imposed by loads that are carried in the dunnage rack, perhaps exacerbated by jolts and the forces of acceleration and deceleration, are distributed between the walls of the dunnage bar and the spacers 70, 70′.

The spacer members 70, 70′ may be provided in a number of alternative embodiments. In one embodiment (FIGS. 6-11), there is a single spacer member 70, 70′ for each channel 36, 38 at one or both ends of the bar. Thus, a bolt hole 72 is defined by the bar's external side walls and septum. A bore 74 is provided in the single spacers 70, 70′ that are inserted into the two channels 36, 38.

As indicated, in one embodiment, the spacer members may have end plates 70, 70′ that effectively serve as depth gauges so that the positioning of the spacer members within the channel can be predictably and accurately reproduced.

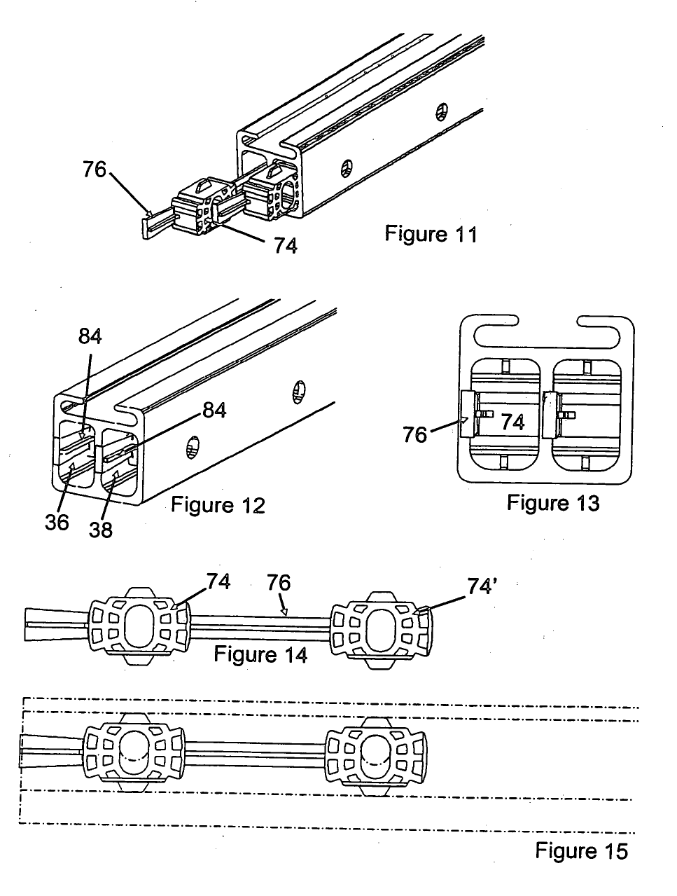

In another embodiment (FIGS. 11-15), two spacer members 74, 74′ are connected by a rod 76. In this embodiment, the separation between the spacers 74, 74′ is uniform. Preferably, one pair of spacers 74, 74′ connected by the rod 76 is inserted within each channel at each end of the dunnage bar for ready attachment to a swing arm or to a rack. In FIG. 14, a guide member 86 extends from a side of the spacer member 74 that is opposite to the side from which the rod 76 extends. If desired, the member 86 may lie in a plane that is inclined to the plane that includes the rod 76 so that an interference fit is created between the two spacer embodiments and the channel.

In other embodiments, the spacer members 74, 74′ may have side edges that can be positioned adjacent to the internal major faces of the channels. For guidance, if desired, a tongue and groove 84, 86 mechanism can be positioned so as to facilitate the insertion and placement of the spacer member 74, 74′. It can be appreciated that the tongue 84 can be provided in a major internal face of a channel. Correspondingly, the groove can be defined respectively in the spacer member. Indeed, the retainer 84 (FIG. 6) may be presented in the form of ears 84 (as shown). If desired, the ears can be so formed as to locate the spacer in a channel and to create an interference fit therebetween

The disclosed dunnage bar system can be designed in order to provide a given deflection by varying certain dimensions (see FIG. 3) for a given material, length, and applied load. One formula is:

$$MI ( moment of Inertia ) = \frac{( ( {B}_{o} * {( {H}_{o} )}^{3} ) - ( {B}_{1} * {( {H}_{1} )}^{3} ) )}{12}$$

[image]

$$Deflection = \frac{f * {( L )}^{3}}{{C}_{1} * E * MI}$$

$$f \text{:} Force$$

$$L \text{:} Length of bar$$

$${C}_{1} \text{:} Constant$$

$$E \text{:} Modulus of Elasticity$$

$$MI \text{:} Moment of Inertia$$

$$Thus , Deflection α 1 / MI$$

In one experiment, an initial reading of deflection was taken on a prototype part with a known wall thickness. The initial deflection reading was taken and other variables were proportioned to optimize deflection, dimensions and weight using the above formula. The moment of inertia can be calculated using the above formula.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A dunnage bar system comprising
a composite bar having a generally rectangular cross section, the bar having four external faces joined by external arcuate corners,
the four external faces including
an impact-absorbing face including two arms of a C-section;
a basal face opposing the impact-absorbing face; and
a pair of side faces oriented between the impact-absorbing and basal faces; and
one or more channels extending at least partially along and within the bar, at least some of the one or more channels having a pair of opposing internal major faces and opposing internal minor faces, each face terminating in an internal corner having a radius.

2. The dunnage bar system of claim 1, wherein
a wall thickness (t₁) separates an external side face of the bar from an internal major face of a channel and a wall thickness (t₂) separates the other external side face from the corresponding internal major face of the other channel.

3. The dunnage bar system of claim 1, further including
a ceiling portion having a thickness (H) that separates a foot portion of the impact-absorbing face from the corresponding internal minor faces of the channels.

4. The dunnage bar system of claim 1, further including
floor portion having a thickness (F) that separates the basal face of the bar from the corresponding minor faces of the channels.

5. The dunnage bar system of claim 1, wherein the arms of the C-section are supported by lateral risers that form a portion of the external side walls.

6. The dunnage bar system of claim 1, further including a septum having a thickness (T) separating each channel in the pair of channels.

7. The dunnage bar system of claim 1, wherein the two arms of the C-section are separated by an opening therebetween, whereby a generally T-shaped section of a protective strip can be inserted into and received by the C-section along at least a part of the length of the bar.

8. The dunnage bar system of claim 8, wherein a radius (R) defines an internal arcuate portion between the major and minor faces of the channels proximate the C-section.

9. The dunnage bar system of claim 8, wherein a radius (r) defines an arcuate portion between the major and minor walls proximate the basal face.

10. The dunnage bar system of claim 9, wherein the ratio of r to R lies between 0.4 and 1.0.

11. The dunnage bar system of claim 1 further including a spacer member that is inserted into one or more of the one or more channels at one or more ends of the bar.

12. The dunnage bar system of claim 11 wherein a bolt hole is provided in an end region of the bar and the one or more spacer members is also provided with an aperture so that the aperture of the one or more spacer members upon insertion into the one or more channels is in registration with the bolt holes in the bar.

13. The dunnage bar system of claim 11 wherein a pair of spacer members is joined by a rod so that upon insertion, the apertures of the spacer members align with the holes in the bar and so that they may receive one or more bolts that extend therethrough.

14. A process for making a composite bar system comprising the steps of:
preparing a first resin bath and at least partially submerging roving;
introducing inner channel mats into the first resin bath;
forming inner channel mats around mandrels and directing roving to center of bar;
forming outer and “C” channel mats before submerging all roving and mats into a second resin bath and shaping the final profile;
introducing final profile of outer and “C” channel mats to a die to provide early curing;
elevating product temperature to a curing temperature;
hardening the final bar profile and at least partially curing the bar, cooling, and severing.
